(19) United States
(12) Patent Application Publication
(10) Pub. No.: US 2024/0015543 A1
(43) Pub. Date: Jan. 11, 2024

(54) ADAPTING A MEASUREMENT BEHAVIOR

(71) Applicant: Lenovo (Singapore) Pte. Ltd., New Tech Park (SG)

(72) Inventors: Sher Ali Cheema, llmenau (DE); Ankit Bhamri, Rödermark (DE); Majid Ghanbarinejad, Chicago, IL (US); Ali Ramadan Ali, Kraiburg am Inn (DE); Vijay Nangia, Woodridge, IL (US)

(21) Appl. No.: 18/250,171

(22) PCT Filed: Oct. 21, 2021
(86) PCT No.: PCT/IB2021/059734

§ 371 Date: Apr. 21, 2023

Related U.S. Application Data
(60) Provisional application No. 63/094,831, filed on Oct. 21, 2020.

(51) Int. Cl. H04W 24/08; H04W 64/00

(52) U.S. Cl. CPC H04W 24/08; H04W 64/00

(57) ABSTRACT

Apparatuses, methods, and systems are disclosed for reporting a UE-selected parameter combination for reciprocity-based Type-II CSI codebook. One apparatus includes a processor and a transceiver that receives a CSI reporting configuration from a mobile communication network, the reporting configuration containing a codebook configuration. The processor identifies a set of antenna ports based on a received set of CSI reference signals and generates at least one coefficient amplitude indicator and one coefficient phase indicator for each antenna port in the identified set of antenna ports. The processor selects a subset of at least one parameter combination from a set of two or more parameter combinations corresponding to the codebook configuration and sends a CSI report to the mobile communication network, the CSI report indicating the selected parameter combination.

### CROSS-REFERENCE TO RELATED APPLICATIONS

This application claims priority to U.S. Provisional Patent Application No. 63/094,831 entitled “DYNAMIC ADAPTATION OF PERIODIC RS MEASUREMENTS/REPORTING IN NON-TERRESTRIAL NETWORK” and filed on Oct. 21, 2020 for Sher Ali Cheema, Ankit Bhamri, Majid Ghanbarinejad, Ali Ramadan Ali, and Vijay Nangia, which application is incorporated herein by reference.

### FIELD

The subject matter disclosed herein relates generally to wireless communications and more particularly relates to dynamic adaptation of periodic Reference Signal (“RS”) measurements/reporting in Non-Terrestrial Network (“NTN”).

### BACKGROUND

Large propagation delays, frequency reuse to enhance link budget, and frequent switching of beams due to high mobility of Low-Earth Orbit (“LEO”) satellites limit the effectiveness of current NR beam management mechanism in the NTN context.

### BRIEF SUMMARY

Disclosed are procedures for dynamic adaptation of periodic RS measurements/reporting in non-terrestrial network. Said procedures may be implemented by apparatus, systems, methods, or computer program products.

One method of a User Equipment (“UE”) for dynamically adapting a measurement behavior includes receiving a measurement-and-reporting configuration from a mobile communication network (i.e., gNB). Here, the configuration maps a plurality of Channel State Information (“CSI”) measurements and reporting periodicities to at least one of: location parameters and signal strength threshold values. The method includes mapping the received configuration to at least one of: a current location and a signal measurement value (i.e., measured signal strength) and dynamically adjusting a measurement behavior in response to the received configuration. Here, the measurement behavior is adjusted based on at least one of: the current location and the signal measurement value (i.e., measured signal strength), where adjusting the measurement behavior comprises at least one of: adjusting a measurement periodicity and adjusting a reporting periodicity.

One method of a mobile communication network for dynamically adapting a measurement behavior includes transmitting a measurement-and-reporting configuration to a UE. Here, the configuration maps a plurality of CSI measurements and reporting periodicities to at least one of: location parameters and signal strength threshold values. The method includes transmitting a set of reference signals and receiving a CSI measurement report from the UE according to the measurement-and-reporting configuration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for dynamically adapting a measurement behavior;

FIG. 2 is a diagram illustrating one embodiment of dynamically adapting a measurement behavior;

FIG. 3 is a diagram illustrating one embodiment of Channel State Information Reference Signal (“CSI-RS”) measurements and reporting periodicity adaptation;

FIG. 4 is a diagram illustrating one embodiment of location-based bandwidth part (“BWP”) and/or satellite beam measurement;

FIG. 5 is a diagram illustrating one embodiment of UE-triggered BWP and/or satellite beam switching based on consecutive measurements;

FIG. 6A is a diagram illustrating one embodiment of satellite-beam-to-cell mapping;

FIG. 6B is a diagram illustrating another embodiment of satellite-beam-to-cell mapping;

FIG. 7A is a diagram illustrating one embodiment of frequency reuse for a group of cells;

FIG. 7B is a diagram illustrating another embodiment of frequency reuse for a group of cells;

FIG. 7C is a diagram illustrating one embodiment of a cell where multiple beams are in a cell and each beam is mapped to a BWP;

FIG. 8 is a block diagram illustrating one embodiment of a user equipment apparatus that may be used for dynamically adapting a measurement behavior;

FIG. 9 is a block diagram illustrating one embodiment of a network apparatus that may be used for dynamically adapting a measurement behavior;

FIG. 10 is a flowchart diagram illustrating one embodiment of a first method for dynamically adapting a measurement behavior; and

FIG. 11 is a flowchart diagram illustrating one embodiment of a second method for dynamically adapting a measurement behavior.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

### Overview+Problem Statement

Generally, the present disclosure describes systems, methods, and apparatus for dynamically adapting a measurement behavior. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Large propagation delays, frequency reuse to enhance link budget, and frequent switching of beams due to high mobility of LEO satellites limit the effectiveness of current 3GPP New Radio (“NR”) beam management mechanism in the NTN context. Especially there may be one-to-one mapping between BWPs and beams, where different geographical areas can be associated with different beams to enable frequency reuse.

In various embodiments, the UE needs to perform/report measurements not only on its serving beam (active BWP) but also of neighboring beams (different BWPs) with BWP switching. However, this will cause downlink (“DL”) signaling overhead and large delay, thus will cause inaccurate beam measurement results. Especially, this will lead to large signaling overhead in the case of LEO satellites where there will be frequent BWP switching, given the association between BWPs and satellite beams.

One way to reduce this signaling overhead is to adopt UE location-based beam switch. However, such measurement-less beam management would not be accurate as radio channel conditions are ignored. This may result in an inaccurate mapping between position of nodes and assumed radio channel conditions especially for users at beam edges.

Disclosed herein are solutions for a dynamic adaptation of periodic Reference Signal (“RS”) measurements and/or reporting in non-terrestrial network. Specifically, UE-assisted and/or UE-controlled beam measurement procedures are implemented where the periodicity of beam measurement and/or reporting is increased (or decreased) based on the UE location or CSI-RS measurements.

As used herein, “periodicity of beam measurement” refers to the rate or frequency at which beam measurements of reference signals (“RSs”) are taken. Similarly, “periodicity of reporting” refers to the rate or frequency at which reports are made regarding the taken beam measurements. Accordingly, an increased periodicity refers to a higher rate of beam measurement (or reporting), such that the interval (or period) between consecutive actions is decreased. Conversely, a decreased periodicity refers to a lower rate of beam measurement (or reporting), such that the interval (or period) between consecutive actions is increased.

Novel signaling and procedures supporting the solutions include dynamic adaptation of periodic RS transmissions and/or measurements and/or CSI reporting for beam-management based on either implicit location information or explicit location information. In various embodiments, implicit location information is inferred from the Layer-1 (“L1”) measurements (e.g., of previous instances) of RS transmissions. In various embodiments, the explicit location information is based on positioning information known to the UE.

Additionally, solutions for beam-management measurements across one or multiple BWPs are described which include dynamic adaptation of which and how many BWPs can be used for periodic RS measurements, depending up on the location of the UE and association of BWP with beam. Further, unified signaling for beam indication and BWP switching is described for when a BWP is associated with a beam.

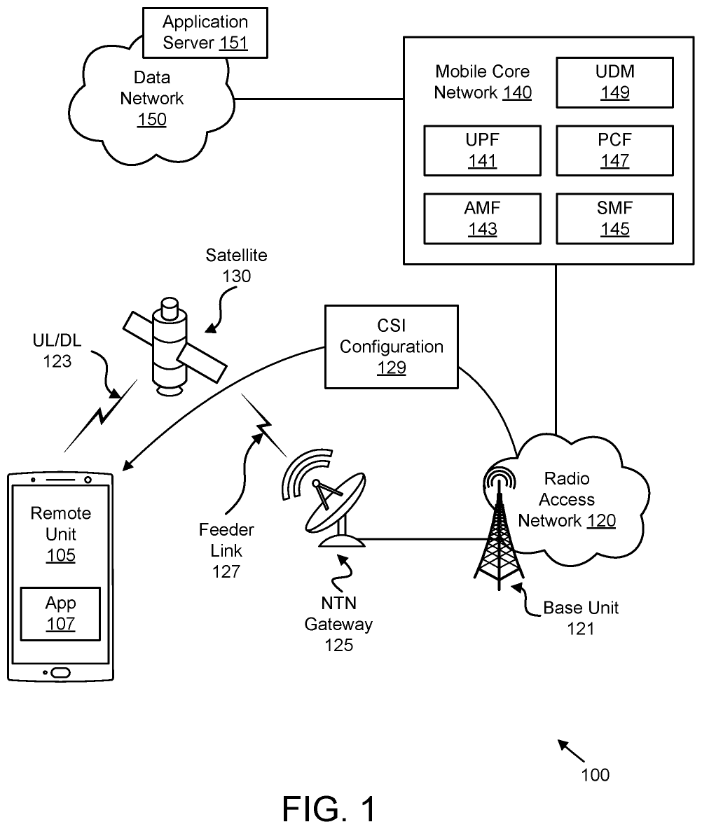

### FIG. 1

FIG. 1 depicts a wireless communication system 100 for dynamically adapting a measurement behavior, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates via a satellite 130 using wireless communication links 123. As depicted, the mobile communication network includes an “on-ground” base unit 121 which serves the remote unit 105 via satellite access.

Even though a specific number of remote units 105, base units 121, wireless communication links 123, RANs 120, satellites 130, non-terrestrial network gateways 125 (e.g., satellite ground/earth devices), and mobile core networks 140 are depicted in FIG. 1, one of skill in the art will recognize that any number of remote units 105, base units 121, wireless communication links 123, RANs 120, satellites 130, non-terrestrial network gateways 125, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. In some embodiments, the remote units 105 communicate in a non-terrestrial network via UL and DL communication signals between the remote unit 105 and a satellite 130. In certain embodiments, the satellite 130 may communicate with the RAN 120 via an NTN gateway 125 using UL and DL communication signals between the satellite 130 and the NTN gateway 125. The NTN gateway 125 may communicate directly with the base units 121 in the RAN 120 via UL and DL communication signals. Furthermore, the UL and DL communication signals may be carried over the wireless communication links 123. Here, the RAN 120 is an intermediate network that provides the remote units 105 with access to the mobile core network 140. Moreover, the satellite 130 provides a non-terrestrial network allowing the remote unit 105 to access the mobile core network 140 via satellite access. While FIG. 1 depicts a transparent NTN system where the satellite 130 repeats the waveform signal for the base unit 121, in other embodiments the satellite 130 (for regenerative NTN system), or the NTN gateway 125 (for alternative implementation of transparent NTN system) may also act as base station, depending on the deployed configuration.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120. Note that in the NTN scenario certain RAN entities or functions may be incorporated into the satellite 130. For example, the satellite 130 may be an embodiment of a Non-Terrestrial base station/base unit.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In various embodiments, the remote unit 105 receives a CSI configuration 129 from the base unit 121, for measurement and reporting of CSI-RS signals. As described in greater detail below, the CSI configuration 129 may contain a mapping table for dynamic adaptions of the CSI measurement behavior, where the remote unit 105 adjusts its frequency/rate of measurement (i.e., measurement periodicity) and/or its frequency/rate of reporting (i.e., reporting periodicity) based on location and/or signal measurement value.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”, also referred to as “Unified Data Repository”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the Fifth Generation Core network (“5GC”). When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for dynamically adapting a measurement behavior apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for dynamically adapting a measurement behavior.

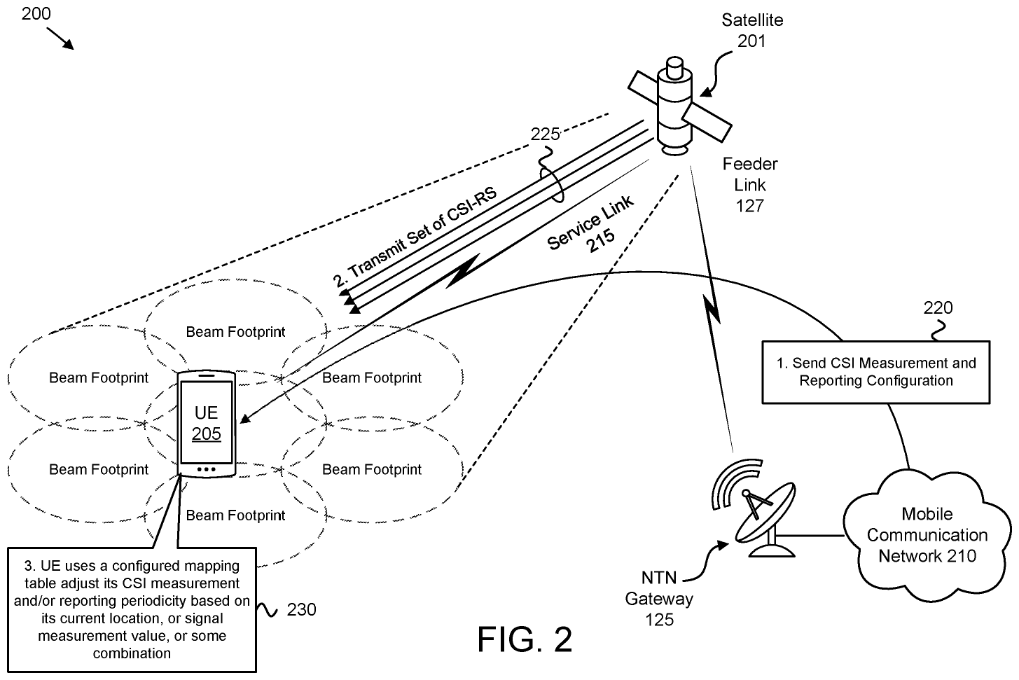

### FIG. 2—General Solution

FIG. 2 depicts an example implementation of a transparent non-terrestrial network (“NTN”) system 200, according to embodiments of the disclosure. The NTN system 200 includes a UE 205, which may be one embodiment of the remote unit 105. The NTN system 200 includes a mobile communication network 210, which may be one embodiment of the mobile core network 140 and/or RAN 120. The mobile communication network 210 is connected to the NTN gateway 125, which connects to the satellite 201 that serves the UE (i.e., via the service link 215) using at least one of a plurality of beams. Note that in other embodiments, the satellite 201 may be replaced with an aerial platform that supports the NTN using a plurality of beams.

As used herein, a transparent-payload NTN system implements frequency conversion and a Radio Frequency (“RF”) amplifier in both up link and down link direction. Thus, the satellite 201 (or aerial platform) corresponds to an RF repeater analogue. Hence, the satellite 201 repeats the NR-Uu radio interface from the feeder link 127 (between the NTN gateway and the satellite) to the service link 215 (between the satellite 201 and the UE 205) and vice versa.

The Satellite Radio Interface (“SRI”) on the feeder link 127 is the NR-Uu. In other words, the satellite 201 does not terminate NR-Uu. The NTN Gateway (“GW”) 125 supports all necessary functions to forward the signal of NR-Uu interface. Different transparent-payload satellites 201 may be connected to the same gNB on the ground. While the NTN depicted in FIG. 2 depicts a transparent-payload NTN system, in other embodiments the NTN system may implement a regenerative-payload system where the satellite 201 acts as the mobile communication network 210 (e.g., performs gNB/RAN functions).

As used herein, in a regenerative-payload satellite architecture, the satellite payload implements regeneration of the signals received from Earth. The satellite payload may also provide Inter-Satellite Links (“ISL”) between satellites. In one embodiment of regenerative-payload NTN, the NR-Uu radio interface on the service link 215 is between the UE 205 and the satellite 201. In another embodiment, the Satellite Radio Interface (“SRI”) is on the feeder link 127 between the NTN gateway 125 and the satellite 201. Note that SRI is a transport link between NTN gateway 125 and the satellite 201. The NTN gateway 125 is a Transport Network Layer node, and supports all necessary transport protocols. In various embodiments, the NTN gateway 125 may implement gNB and/or RAN functions, for example beam management functions in NTN. In other embodiments, the satellite 201 may implement gNB and/or RAN functions, for example beam management functions in NTN.

The projection of each beam of the satellite 201 to the ground defines a beam footprint. As described herein, the UE may dynamically adapt its rate of RS measurement and reporting based on its position relative to the beam footprint. Here, the relative position may be explicitly determined from the UE location (i.e., geographical location) or may be implicitly indicated by a current RS measurement, such as Layer-1 Reference Signal Received Power (“L1-RSRP”), Layer-1 Signal-to-Interference-Plus-Noise Ratio (“L1-SINR”), Reference Signal Received Quality (“RSRQ”), Received Signal Strength Indicator (“RSSI”), etc. Note here that “Layer-1” refers to the physical layer (“PHY”) of the NR/LTE protocol stack.

FIG. 2 additionally depicts a procedure for dynamic adaptation of measurement/reporting. At Step 1 the mobile communication network 210 sends a CSI measurement-and-reporting configuration to the UE 205 (see messaging 220). Here, the configuration maps a plurality of CSI measurements and reporting periodicities to at least one of: location parameters and signal strength threshold values.

At Step 2, the network transmits a set of CSI-RS (e.g., via satellite 201) which may be received and measured by the UE 205 (see signaling 225).

At Step 3, the UE 205 dynamically adjusts its measurement behavior based on at least one of: the current location and the signal measurement value (i.e., measured signal strength), where adjusting the measurement behavior comprises at least one of: adjusting a measurement periodicity and adjusting a reporting periodicity (see block 230).

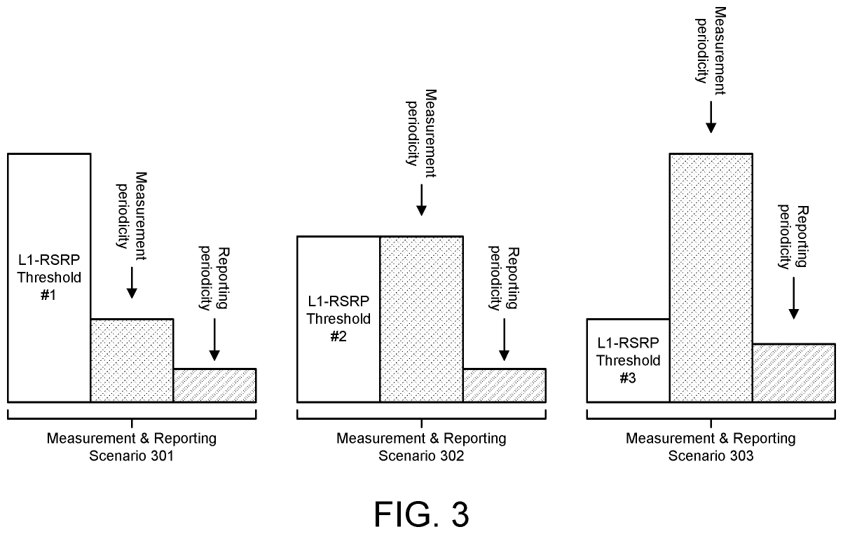

Described herein are enhancements to the beam-management related measurements and corresponding reporting in NTN systems. As beam-management is typically dependent up on periodic RS transmissions such as for CSI-RS and corresponding CSI reporting (e.g., periodic/semi-persistent/aperiodic CSI reporting), where the periodicity can be semi-statically (re-) configured by Radio Resource Control (“RRC”) configuration. Accordingly, the below descriptions provide solutions to:
A) Dynamically adapt the periodicity of such RS and/or measurements and/or CSI reporting depending upon latest N (N>=1) measurements such as L1-RSRP, L1-SINR, RSRQ, RSSI such that if for example the average of those N measurements drops below a pre-configured threshold (or threshold-range), then the periodicity can be adjusted (e.g., increased) accordingly, as shown in example FIG. 3.
B) Dynamically adapt the periodicity of such RS and corresponding measurements over one or multiple BWPs based on the location information, where the BWP can be associated with a beam.

One of the main benefits of the proposed solution is to dynamically adapt the CSI-RS transmissions and/or measurement and/or reporting as needed depending up on the location of the UE to avoid the need to update such configuration for NTN systems where either long Round-Trip Time (“RTT”) (for Geosynchronous Equatorial Orbit (“GEO”) satellites) or very fast changing spatial location with respect to beam (for Low-Earth Orbit (“LEO”) satellites) (or fast-changing LEO satellite beam for a fixed physical location of the UE) can be expected.

### Embodiment 1: L1-RSRP/L1-SINR/RSRQ/RSSI Level Based Adaptive Beam Measurements

According to embodiment of the first solution, the periodicity (i.e., rate) of the CSI measurements and/or corresponding CSI reporting is dynamically adapted at the UE 205 based on the quality of current CSI-RS measurements and/or the quality of a particular number of most recent CSI-RS measurements (i.e., the past N CSI-RS measurements). In one embodiment, the quality of a CSI-RS measurement corresponding to its L1-RSRP value. Note that while the embodiments of the first solution are described as using a L1-RSRP value, this value is exemplary of a CSI-RS measurement and may be combined or replaced with a L1-SINR value, a RSRQ value, and/or a RSSI value.

In one implementation of the first solution, the mobile communication network (e.g., gNB) semi-statically configures the UE with a mapping table for CSI-RS measurements (e.g., L1-RSRP of the current beam) and a CSI measurement and/or CSI reporting periodicity, as shown in Table 1 below.

TABLE 1
Example of configured table for CSI-RS measurement periodicity
adaptation and/or CSI reporting periodicity adaptation

| | Measurement | Slot offset (i.e., |
|---|---|---|
| | Interval | delay) to apply new |
| L1-RSRP value (X dBm) | (slots) | periodicity (slots) |
| X >= −130 | 16 | 8 |
| −140 <= X < −130 | 8 | 4 |
| −150 <= X < −140 | 4 | 2 |

When the UE performs measurements and if the measurement value is below a certain threshold value (or generally within a value-range, i.e., Threshold_1<=measurement value<Threshold_2) in the configured table, then the UE is expected to measure CSI-RS (e.g., CSI resource periodicity and offset) and/or perform corresponding CSI reporting (e.g., CSI report periodicity and offset) with a different periodicity.

In some embodiments, the new (adapted) periodicity is applied after K slots, where the value of K may be predetermined (e.g., specified in specification) or separately configured (e.g., indicated/provided to the UE). Alternatively, the configured mapping table may include the value of K, as depicted in the right-most column of Table 1 (last column, for each row entry in Table 1).

In some embodiments, the UE reports the CSI measurements to the mobile communication network (e.g., gNB) and the mobile communication network (e.g., gNB) also compares the measurement value(s) against a threshold in the configured table and applies new periodicity to align with UE's interpretation. In certain embodiments, the mobile communication network (e.g., gNB) sets the periodic interval for the reporting with a minimum and maximum reporting time, e.g., 5 ms, 10 ms, . . . , 40 ms. However, the UE only reports the measurements during this time window if the measured L1-RSRP level is below certain threshold value (e.g., within a range between successive thresholds).

In another implementation of the first solution, based on the current measurements, the UE may send a scheduling request and/or configuration request for activating (e.g., Medium Access Control (“MAC”) Control Element (“CE”) activation) or triggering (e.g., triggering based on a field in a Downlink Control Information (“DCI”)) semi-persistent CSI-RS transmission and/or semi-persistent CSI reporting. In one embodiment, the request is a single bit transmission on either Physical Uplink Control Channel (“PUCCH”) or Physical Uplink Shared Channel (“PUSCH”). In another embodiment, the UE may request the gNB for aperiodic CSI-RS transmission and/or aperiodic CSI reporting.

When configured with multiple BWPs, the UE measures the L1-RSRP level on the active BWP. In another implementation of the first solution, the UE may also measure the L1-RSRP level on one or more inactive BWPs. Note here that the UE is configured with multiple BWPs, with at least one BWP being an inactive BWP. In some embodiments, the UE only measures on the inactive BWP(s) if the measured L1-RSRP level (e.g., based on RS) in the current active BWP falls below a configured threshold level. In certain embodiments, the configured mapping table indicates at what L1-RSRP level the UE is to measure on the one or more inactive BWPs.

### FIG. 3

FIG. 3 depicts one example of CSI-RS measurements and reporting periodicity adaptation, according to embodiments of the first solution. When the UE measures CSI-RS L1-RSRP above the L1-RSRP threshold #1, then the first measurement and reporting scenario 301 applies. Here, the UE performs CSI-RS measurements at a relatively low rate (indicated by the low measurement periodicity) and also reports CSI-RS measurement at a relatively low rate (indicated by the low reporting periodicity).

However, when the UE measures CSI-RS L1-RSRP below the L1-RSRP threshold #1 and above the L1-RSRP threshold #2, then the second measurement and reporting scenario 302 applies. Here, the UE performs CSI-RS measurements at an increased rate (indicated by the moderate measurement periodicity) but still reports CSI-RS measurement at the relatively low rate (indicated by the low reporting periodicity). When the UE measures CSI-RS L1-RSRP below the L1-RSRP threshold #2 and above the L1-RSRP threshold #3, then the third measurement and reporting scenario 303 applies. Here, the UE performs CSI-RS measurements at a relatively high rate (indicated by the high measurement periodicity) and also reports CSI-RS measurement at an increased rate (indicated by the moderate reporting periodicity).

### Embodiment 2: UE Location-Assisted Beam Measurements

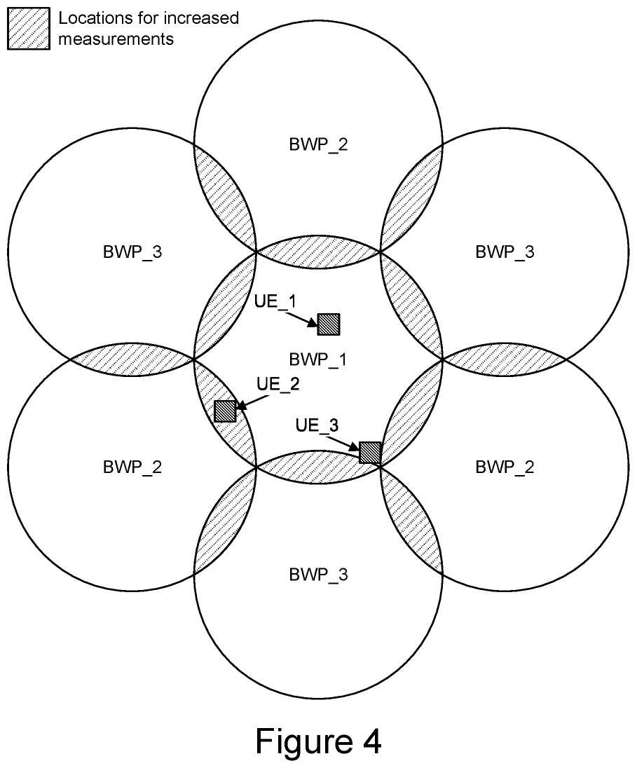

According to embodiments of the second solution, the UE may adjust the periodicity (i.e., rate) of CSI-RS measurements and/or CSI reporting periodicity based on its location. The location can be obtained via e.g., GNSS (RAT-independent positioning techniques) for UEs equipped with it or with other positioning methods (e.g., RAT-dependent, UE-based/UE-assisted positioning techniques e.g., Downlink Time Difference of Arrival (“DL-TDOA”), RTT, Downlink Angle of Departure (“DL-AoD”), Uplink Angle of Arrival (“UL-AoA”), Enhanced Cell-ID (“E-CID,” refers to a positioning method)). A mapping table is configured based on the location (e.g., generally each location entry in the table can include a set of locations e.g., a list of locations coordinates or location coordinate of a center with a particular/configured radius), with one or more of measurement periodicity, measurement on active/inactive BWPs, and/or CSI reporting periodicity. This reduces the signaling overhead as only those UEs do measurements that are at the beam edges/boundaries as shown in FIG. 4.

### FIG. 4

FIG. 4 depicts an example of location-based BWP/beam measurement, according to embodiments of the disclosure. As shown in FIG. 4, at least three UEs are served by an NTN, where the first UE (depicted as “UE_1”) in location 1 is positioned near the center of the satellite beam corresponding to BWP_1, a second UE (depicted as “UE_2”) in location 2 is positioned near the beam boundary between BWP_1 and BWP_2, and a third UE (depicted as “UE_3”) in location 3 is located near the intersections of BWP_1, BWP_2 and BWP_3.

Because the UE_1 is near the center of the satellite beam, it does not need to measure and report measurement frequently. Moreover, the UE_1 may only need to measure and report for the current active BWP (e.g., BWP_1). However, because the UE_2 is in an area corresponding to increased measurements, the UE_2 must measure and report L1-RSRP levels at a higher rate than UE_1. Additionally, the UE_2 measures and reports L1-RSRP levels not only on active BWP 1 but also on inactive BWP 2. Further, the UE_3 in location 3 is required to perform CSI-RS measurements on BWP_1, BWP_2, and BWP_3. While the UE_3 is not depicted as being in a location/area for increased measurement, the frequency of measurements and reporting for UE 3 may also be increased as compared to the UE_1 based on its location. In further embodiments, frequency of measurements and reporting for the UEs may also be adjusted based on UE mobility (i.e., increased if moving away from the beam center or decreased if moving towards the beam center). Note that while the embodiments of the second solution are described as measuring a L1-RSRP value, this value is exemplary of a CSI-RS measurement and may be combined or replaced with a L1-SINR value, a RSRQ value, and/or a RSSI value.

Table 2 represents a mapping table for the scenario depicted in FIG. 4.

TABLE 2
Example of configured table for location-based
CSI-RS measurement and reporting periodicity

| | Measure- | | |
|---|---|---|---|
| | ment | Reporting | |
| | period- | period- | |
| Locations | icity | icity | BWP |
| Location 1 | 30 ms | 60 ms | BWP 1(active) |
| Location 2 | 5 ms | 10 ms | BWP 1 (active)/BWP 2 (inactive) |
| Location 3 | 5 ms | 5 ms | BWP 1 (active)/BWP 2, 3 (inactive) |

In some embodiments, a location parameter may be indicated by a range of coordinate parameters, for example a range of X and Y values on a plane, indicating a rectangle, or Cartesian coordinates for a center and a radius, indicating a circle. In some embodiments, non-Cartesian coordinates may be used to indicate a location.

In one implementation of the second solution, the UE is configured only with a limited set of locations for the respective beam indicating where increased rate of measurements and/or reporting is needed, thereby reducing the size of the mapping table. In this implementation, a UE that is at a location that is not in the table instead follows a default measurement and reporting periodicity.

A non-terrestrial transmit-receive point (“NT-TRP”), which may be a gNB in the case of regenerative payload or a relay in the case of transparent payload, may apply beams in one of the two following methods:
Earth-fixed beams: In this method, a beam footprint remains fixed as the NT-TRP moves. In order to realize this method, the NT-TRP performs fine beamforming in order to provide a virtually fixed beam footprint.
Earth-moving beams: In this method, beams are fixed from the NT-TRP's viewpoint. Hence, as the NT-TRP moves, the beam footprints move with it.

In some embodiments, with earth-fixed beams, a UE may receive semi-static configurations with fixed location parameters for determining measurement and reporting periodicities.

In some embodiments, with earth-moving beams, a UE may receive additional information indicating how to interpret the location parameter over time.

In some embodiments, once the UE switches from one beam to another beam, which may comprise switching a BWP or a cell handover, the UE may switch to a longer periodicity for measurement and reporting for a certain period of time. The parameters may be configured by the network.

### Embodiment 3: Signaling Enhancements for BWP/Beam Switching

According to embodiments of a third solution, when each BWP is associated with a beam, then the UE is not expected to be signaled with both BWP indication field and TCI indication field in the DCI to prevent the redundancy in terms of BWP or beam switching. Thus, if BWP index is indicated in the DCI, then the UE is also expected to change the transmit/receive beam according to the BWP configuration. In one implementation, RRC configuration for BWP is enhanced to include the associated beam by including a source/reference RS with QCL Type-D assumption.

### Embodiment 4: BWP/Beam Switching Triggering

According to embodiments of a fourth solution, the UE may trigger or request BWP/beam switching based on L1-measurements on the pre-configured BWPs/beams with full or reduced periodicity depending on the L1-RSRP level and/or the location, as described in the first and second solutions. Note that while the embodiments of the fourth solution are described with respect to a Reference Signal Received Power (“RSRP”) value, this value is exemplary of a CSI-RS measurement and may be combined or replaced with a Signal-to-Interference-Plus-Noise Ratio (“SINR”) value, a RSRQ value, and/or a RSSI value.

To reduce the signaling overhead of the reporting, instead of reporting the measurements of the intended BWPs/Beams, the UE may trigger BWP/beam switching by sending a combined ID (e.g., identifying a combination of beam and BWP, such as concatenated BWP-ID & Beam ID or another ID mapped to a combination of beam and BWP). Here, the Beam ID may correspond to a CSI-RS Resource Identifier (“CRI”) or SSB Resource Identifier (“SSBRI”) of one or more BWPs/Beams that show increasing level of RSRP during the measurement points of the, e.g., consecutive RS (e.g., CSI-RS) resources or during a measurement window.

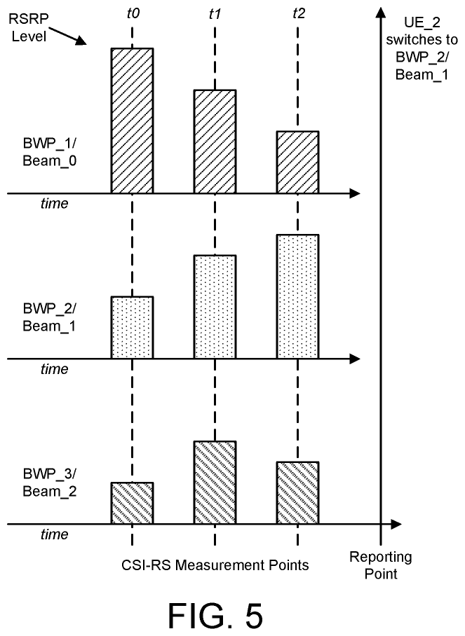

### FIG. 5

FIG. 5 depicts one example of UE triggered BWP/beam switching based on consecutive measurements, according to embodiments of the disclosure. The depicted measurements correspond to the UE_2 described above with reference to FIG. 4, which is located in an area for increased measurements due to its proximity to beam boundaries (i.e., between BWP_1 and BWP_2—corresponding to beam_0 and beam_1, respectively).

At a first CSI-RS measurement point (i.e., time ‘t₀’), the UE_2 performs L1 measurements and determines an RSRP for BWP_1 (beam_0) that is significantly higher than the RSRP for BWP_2 (beam_1) and BWP_3 (beam_2), the latter two measuring a relatively low RSRP. Later, at a second CSI-RS measurement point (i.e., time ‘t₁’), the UE_2 again performs L1 measurements and determines only a moderate RSRP for BWP_1 (beam_0) that about the same as the RSRP for BWP_2 (beam_1), while the RSRP for BWP_3 (beam_2) remains low. At the third CSI-RS measurement point (i.e., time ‘t₂’), the UE_2 performs L1 measurements and determines an RSRP for BWP_2 (beam_1) that is significantly higher than the RSRPs for BWP_1 (beam_0) and BWP_3 (beam_2), the latter two measuring a relatively low RSRP.

Accordingly, at the reporting point, the UE_2 triggers BWP switching to BWP_2/beam_1 based on the consecutive measurements on BWP_1, BWP_2, and BWP_3.

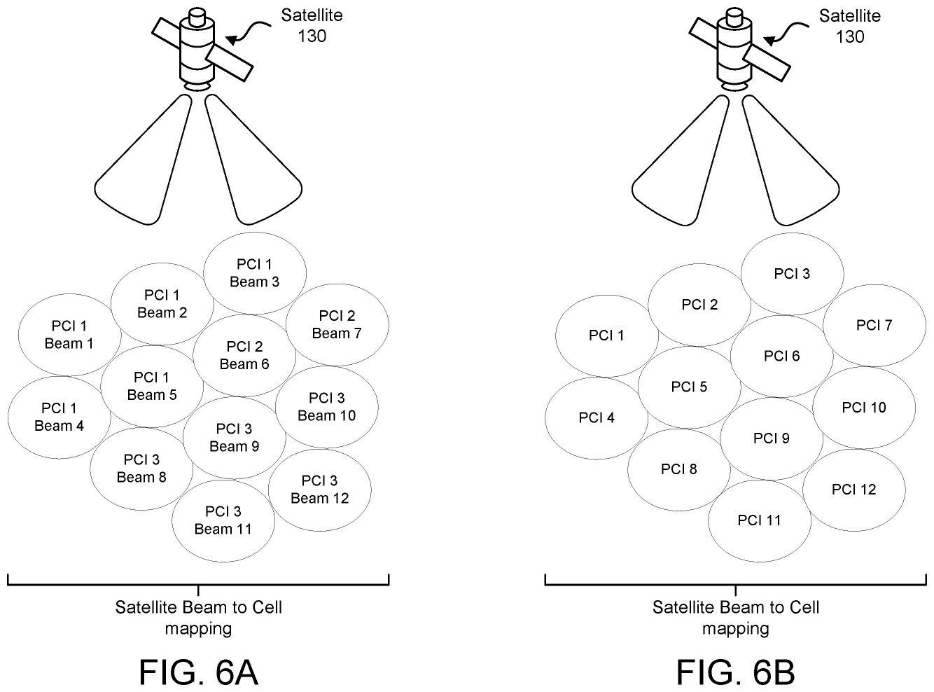

### FIG. 6

### Regarding Beam Management and BWPs in NTN

FIGS. 6A-6B depicts cell mapping scenarios in NTN. FIG. 6A depicts one option (referred to as “option (a)”) where several satellite beams are in the same cell. In the depicted embodiment, the Physical Cell Identity (“PCI”) identifies each cell in the NTN. Accordingly, all beams comprising a particular cell share the same PCI. Note that a satellite beam can consist of one or more SSB beams.

FIG. 6B depicts another option (referred to as “option (b)”) where each satellite beam is considered as cell. In the depicted embodiment, the PCI is unique to each beam in the NTN, thus no beam identifier is needed. Note that a satellite beam can consist of one or more SSB beams.

In case of operation with one beam per cell, physical layer (i.e., L1) behavior for NTN is similar to terrestrial network behavior, although more higher layer procedures are required due to frequent cell/beam handover, especially for satellite access provided by LEO satellites. In case of operation with multiple beams per cell, physical layer (i.e., L1) behavior for NTN may reuse L1 beam management techniques defined for terrestrial networks.

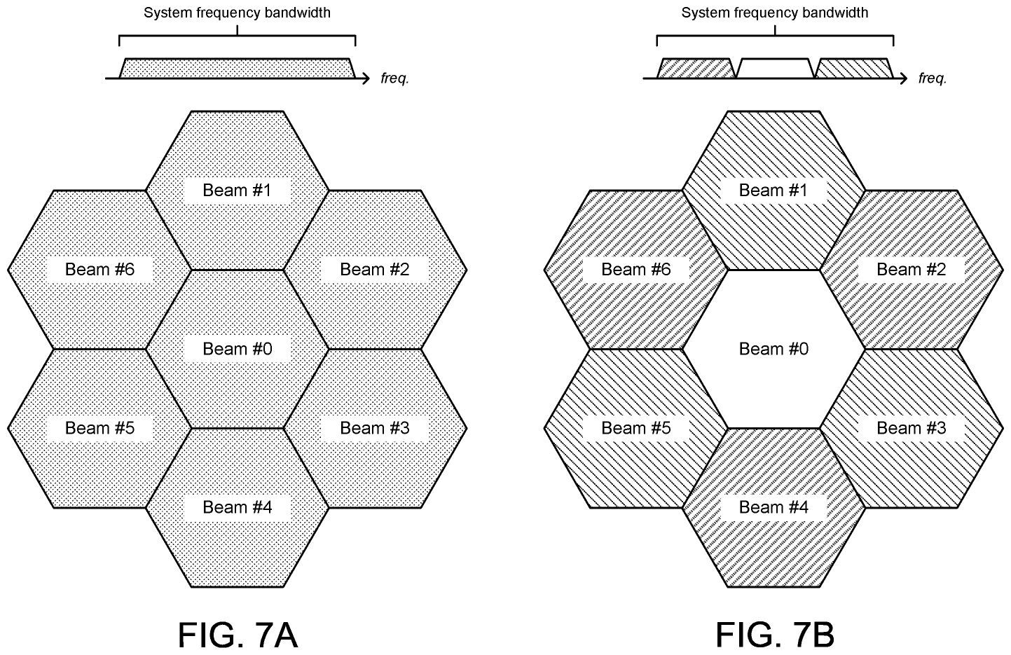

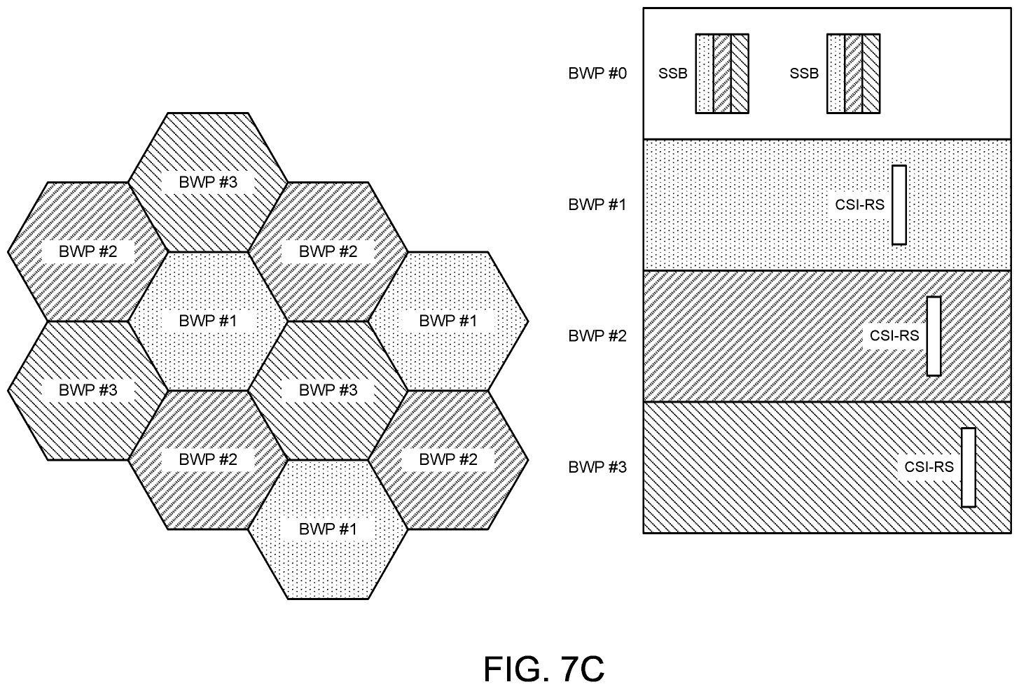

### FIG. 7

FIG. 7A depicts a first frequency use scenario. In FIG. 7A, the frequency reuse factor (“FRF”) is equal to one. Therefore, all cells/beams use the same radio frequencies (thus introducing inter-cell/inter-beam interference). However, with Frequency Reuse Factor-1 (FRF-1) scheme, the per-beam bandwidth can occupy the entire wideband carrier.

FIG. 7B depicts a second frequency use scenario, where a frequency reuse factor of 3 is implemented to reduce inter-cell interference. In NR NTN, frequency reuse schemes (e.g., where the FRF is greater than one) may be implemented to mitigate inter-cell (and/or inter-beam) co-channel interference. In certain embodiments, Spatial Frequency reuse techniques are used to improve the SINR; however, Spatial Frequency reuse inherently limits the per-beam bandwidth and the system capacity. The traditional Frequency Reuse Factor-3 (FRF-3) scheme, for example, offers a protection against inter-cell interference. However, only a third of the spectral resources are used within each cell. NTN System level simulations have shown potential gains of FRF-3 scheme.

In case of frequency reuse larger than one, the concept of using BWPs to enable a frequency reuse may be implemented, e.g., mapping different BWPs to different parts of the system bandwidth and different beams would allow L1 based mobility within a large cell. Specifically, for a flexible Frequency Reuse, a UE may be configured with beam-specific BWP to replace the traditional role of the component carrier, which is not as flexible as a BWP. Thus, for NTN the same component carrier may be used on all cells (e.g., frequency reuse of 1), but each beam is assigned a beam-specific BWP. For the configuration of beam specific BWPs in NTN, the configuration parameters may include starting position, size and the subcarrier spacing—as defined for terrestrial networks. In addition, for NTN an indication of the associated beam needs to be added, i.e., a beam-index, such as CSI-RS associated with the beam.

FIG. 7C shows a scenario where multiple beams are in a cell and each beam is mapped to a BWP. The UE first uses the initial BWP #0, but then switches from the initial BWP #0 to the serving BWP #x. Similarly in this case, SSBs via all beams within the cell are transmitted on BWP #0. The UE performs DL synchronization and Random-Access Channel (“RACH”) procedure on BWP #0. After entering the RRC Connected state, the BWP corresponding to the detected SSB (i.e., satellite beam) may be configured to the UE as an active BWP (e.g., RRC-configured BWP). This requires that the satellite beam transmits the SSB on BWP #0 in addition to transmit PDCCH/PDSCH on the associated BWP.

In other words, the BWP #0 can be used for initial cell access with all beams and corresponding SSBs. For connected UE, an active BWP #1, #2, or #3 can be used with several satellite beams. Whenever the UE makes measurements on a BWP that is different from the BWP of the current serving satellite beam, the UE will need to retune its carrier frequency for measurements on the non-active BWP and perform frequency compensation to report measurements frequently—i.e., every 10 seconds typically in LEO scenario with earth-moving beams.

In various embodiments, the UE will measure CSI resources on different BWPs for multiple times with BWP switching. For example, UE firstly measures CSI resource #1 on active BWP as BWP #1, then UE switches to BWP #2 after receiving DCI indicating BWP switching from the gNB. Thereafter, an aperiodic CSI report associated with CSI resource #2 on BWP #2 would be triggered, the UE performs CSI measurement on BWP #2. Similarly, the UE may switch to BWP #3 for CSI resource #3 measurement. However, this BWP switching may cause large delay and DL signaling overhead as every time the UE needs to receive BWP switching indication from the gNB. The large delay will cause inaccurate beam measurement results. Besides the DL overhead, the UL signaling overhead for CSI report will be large as differential RSRP report cannot be applied.

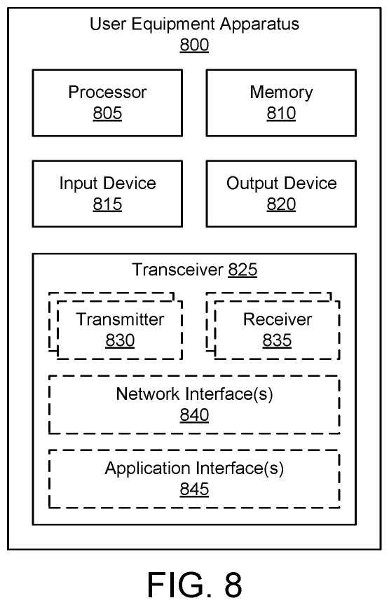

### FIG. 8

FIG. 8 depicts a user equipment apparatus 800 that may be used for dynamically adapting a measurement behavior, according to embodiments of the disclosure. In various embodiments, the user equipment apparatus 800 is used to implement one or more of the solutions described above. The user equipment apparatus 800 may be one embodiment of the remote unit 105 and/or the UE 205, described above. Furthermore, the user equipment apparatus 800 may include a processor 805, a memory 810, an input device 815, an output device 820, and a transceiver 825.

In some embodiments, the input device 815 and the output device 820 are combined into a single device, such as a touchscreen. In certain embodiments, the user equipment apparatus 800 may not include any input device 815 and/or output device 820. In various embodiments, the user equipment apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. In some embodiments, the transceiver 825 communicates with one or more cells (or wireless coverage areas) supported by one or more base units 121. In various embodiments, the transceiver 825 is operable on unlicensed spectrum. Moreover, the transceiver 825 may include multiple UE panels supporting one or more beams. Additionally, the transceiver 825 may support at least one network interface 840 and/or application interface 845. The application interface(s) 845 may support one or more APIs. The network interface(s) 840 may support 3GPP reference points, such as Uu, N1, PC5, etc. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the processor 805 controls the user equipment apparatus 800 to implement the above described UE behaviors. In certain embodiments, the processor 805 may include an application processor (also known as “main processor”) which manages application-domain and operating system (“OS”) functions and a baseband processor (also known as “baseband radio processor”) which manages radio functions.

### Novel UE Behavior

In various embodiments, the processor 805 receives (i.e., via the transceiver 825 implementing a radio interface) a measurement-and-reporting configuration from a mobile communication network (i.e., gNB), where the configuration maps a plurality periodicities, i.e., CSI measurements and/or reporting periodicities, to positioning information. Here, the positioning information may include location parameters (e.g., indicating geographic location) and/or signal strength threshold values (e.g., implying a location relative to the beam center).

The processor 805 maps the received configuration to at least one of: a current location and a signal measurement value (i.e., measured signal strength, such as L1-RSRP, L1-SINR, RSRQ, RSSI). The processor 805 dynamically adjusts a measurement behavior in response to the received configuration. Here, the measurement behavior is adjusted based on at least one of: the current location and the signal measurement value (i.e., measured signal strength), where adjusting the measurement behavior includes at least one of: adjusting a measurement periodicity and a adjusting a reporting periodicity.

In some embodiments, the configuration includes a mapping table that maps a location parameter (e.g., a geographic area) with a corresponding CSI measurement periodicity, a corresponding CSI reporting periodicity, and/or a corresponding BWP configuration. In some embodiments, the configuration includes a mapping table that maps a received signal threshold value (or a range of signal strength values) with a corresponding CSI measurement periodicity, a corresponding CSI reporting periodicity, and/or a corresponding BWP configuration.

In some embodiments, dynamically adjusting the measurement behavior includes adjusting the measurement behavior based on a comparison of a measured signal strength to a received signal threshold value. In certain embodiments, the processor 805 further performs signal strength measurements on both an active BWP and on at least one inactive BWP, e.g., when the measured signal strength is below the received signal threshold value.

In some embodiments, dynamically adjusting the measurement behavior includes adjusting the measurement behavior based on the current location. In certain embodiments, the processor 805 further performs measurement on both an active BWP and also on at least one inactive BWP based on the current location, e.g., when the UE is located in a specific area or when the UE is within a predetermined distance from the beam boundary.

In some embodiments, the processor 805 further requests the mobile communication network for triggering or activating a CSI measurement-and-reporting procedure, said request based on a signal measurement value or on a current location. In some embodiments, the processor 805 further requests the mobile communication network for configuring a mapping table for CSI measurement periodicities and/or CSI reporting periodicities, said request based on a signal measurement value or on a current location.

In some embodiments, the transceiver 825 further receives a second configuration (e.g., receives an RRC configuration message) that associates each configured BWP with a specific beam and receives DCI containing a BWP index in a BWP indication field. In such embodiments, the processor 805 automatically switches to a beam associated with the indicated BWP in response to the BWP index in DCI. In certain embodiments, the second configuration associates a first BWP with a first beam by including a source RS with a QCL type-D assumption. In certain embodiments, when a BWP is associated with at least one beam, then the UE does not consider a TCI indication field in the corresponding DCI format.

In some embodiments, identifying a current location of the UE includes receiving an explicit indication from the mobile communication network. In some embodiments, the processor 805 further triggers a BWP switch by sending a combined BWP and beam ID (e.g., BWP-ID & Beam ID). In some embodiments, the processor 805 further triggers a beam switch by sending a combined BWP and beam ID (e.g., BWP-ID & Beam ID).

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to enhanced SSB patterns and/or mobile operation. For example, the memory 810 may store various parameters, panel/beam configurations, resource assignments, policies, and the like as described above. In certain embodiments, the memory 810 also stores program code and related data, such as an operating system or other controller algorithms operating on the apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 820 may include a wearable display separate from, but communicatively coupled to, the rest of the user equipment apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 communicates with one or more network functions of a mobile communication network via one or more access networks. The transceiver 825 operates under the control of the processor 805 to transmit messages, data, and other signals and also to receive messages, data, and other signals. For example, the processor 805 may selectively activate the transceiver 825 (or portions thereof) at particular times in order to send and receive messages.

The transceiver 825 includes at least transmitter 830 and at least one receiver 835. One or more transmitters 830 may be used to provide UL communication signals to a base unit 121, such as the UL transmissions described herein. Similarly, one or more receivers 835 may be used to receive DL communication signals from the base unit 121, as described herein. Although only one transmitter 830 and one receiver 835 are illustrated, the user equipment apparatus 800 may have any suitable number of transmitters 830 and receivers 835. Further, the transmitter(s) 830 and the receiver(s) 835 may be any suitable type of transmitters and receivers. In one embodiment, the transceiver 825 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 825, transmitters 830, and receivers 835 may be implemented as physically separate components that access a shared hardware resource and/or software resource, such as for example, the network interface 840.

In various embodiments, one or more transmitters 830 and/or one or more receivers 835 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 830 and/or one or more receivers 835 may be implemented and/or integrated into a multi-chip module. In some embodiments, other components such as the network interface 840 or other hardware components/circuits may be integrated with any number of transmitters 830 and/or receivers 835 into a single chip. In such embodiment, the transmitters 830 and receivers 835 may be logically configured as a transceiver 825 that uses one more common control signals or as modular transmitters 830 and receivers 835 implemented in the same hardware chip or in a multi-chip module.

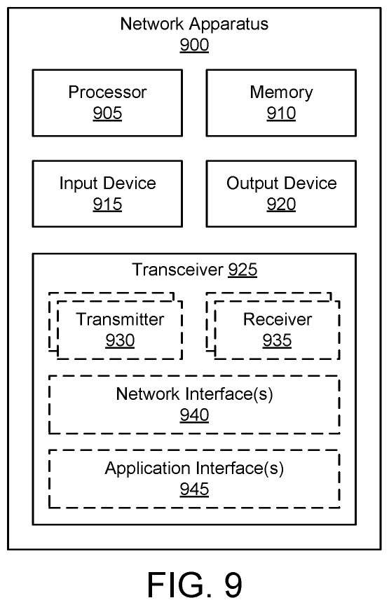

### FIG. 9

FIG. 9 depicts a network apparatus 900 that may be used for dynamically adapting a measurement behavior, according to embodiments of the disclosure. In one embodiment, network apparatus 900 may be one implementation of a RAN entity, such as the base unit 121, the NTN gateway 125, the satellite 130, the satellite 201, and/or the RAN entity in the mobile communication network 210, as described above. Furthermore, the network apparatus 900 may include a processor 905, a memory 910, an input device 915, an output device 920, and a transceiver 925.

In some embodiments, the input device 915 and the output device 920 are combined into a single device, such as a touchscreen. In certain embodiments, the network apparatus 900 may not include any input device 915 and/or output device 920. In various embodiments, the network apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. Here, the transceiver 925 communicates with one or more remote units 105. Additionally, the transceiver 925 may support at least one network interface 940 and/or application interface 945. The application interface(s) 945 may support one or more APIs. The network interface(s) 940 may support 3GPP reference points, such as Uu, N1, N2 and N3. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a CPU, a GPU, an auxiliary processing unit, a FPGA, or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the network apparatus 900 is a RAN node (e.g., gNB) that communicates with one or more UEs, as described herein. In such embodiments, the processor 905 controls the network apparatus 900 to perform the above described RAN behaviors. When operating as a RAN node, the processor 905 may include an application processor (also known as “main processor”) which manages application-domain and operating system (“OS”) functions and a baseband processor (also known as “baseband radio processor”) which manages radio functions.

### Novel NW Behavior

In various embodiments, the processor 905 controls the transceiver 925 (i.e., implementing a radio interface) to transmit a measurement-and-reporting configuration to a UE, where the configuration maps a plurality periodicities, i.e., CSI measurements and/or reporting periodicities, to positioning information. Here, the positioning information may include location parameters (e.g., indicating geographic location) and/or signal strength threshold values (e.g., implying a location relative to the beam center). Additionally, the processor 905 controls the transmitter to transmit a set of reference signals and receive a CSI measurement report from the UE according to the measurement-and-reporting configuration.

In some embodiments, the receiver further receives an indication from the UE, wherein the processor 905 initiates transmission of the measurement-and-reporting configuration based on the indication from the UE. In some embodiments, the transceiver 925 receives a request from the UE for triggering or activating a CSI measurement-and-reporting procedure, said request based on a signal measurement value of the UE or on a current location of the UE. In some embodiments, the transceiver 925 receives a request from the UE for configuring a mapping table for CSI measurement periodicities and/or CSI reporting periodicities, said request based on a signal measurement value of the UE or on a current location of the UE.

In some embodiments, the UE is configured with multiple BWPs. In such embodiments, the transceiver 925 further transmits a second configuration (e.g., transmits a RRC configuration message) that associates each configured BWP with a specific beam and additionally transmits DCI containing a BWP index in a BWP indication field, where the DCI triggers the UE to switch to a beam associated with the indicated BWP in response to the BWP index in DCI. In certain embodiments, the second configuration associates a first BWP with a first beam by including a source RS with a QCL type-D assumption. In certain embodiments, when a BWP is associated with at least one beam, then the UE does not consider a TCI indication field in the corresponding DCI format.

In some embodiments, the configuration includes a mapping table that maps a location parameter (e.g., a geographic area) with a corresponding CSI measurement periodicity, a corresponding CSI reporting periodicity, and/or a corresponding BWP configuration. In some embodiments, the configuration includes a mapping table that maps a received signal threshold value (or a range of signal strength values) with a corresponding CSI measurement periodicity, a corresponding CSI reporting periodicity, and/or a corresponding BWP configuration. In some embodiments, the processor 905 further identifies a current location of the UE and transmits an explicit indication of the current location to the UE.

The memory 910, in one embodiment, is a computer readable storage medium. In some embodiments, the memory 910 includes volatile computer storage media. For example, the memory 910 may include a RAM, including dynamic RAM (“DRAM”), synchronous dynamic RAM (“SDRAM”), and/or static RAM (“SRAM”). In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to enhanced SSB patterns and/or mobile operation. For example, the memory 910 may store parameters, configurations, resource assignments, policies, and the like, as described above. In certain embodiments, the memory 910 also stores program code and related data, such as an operating system or other controller algorithms operating on the apparatus 900.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, an LCD display, an LED display, an OLED display, a projector, or similar display device capable of outputting images, text, or the like to a user. As another, non-limiting, example, the output device 920 may include a wearable display separate from, but communicatively coupled to, the rest of the network apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, the output device 920 may be located near the input device 915.

The transceiver 925 includes at least transmitter 930 and at least one receiver 935. One or more transmitters 930 may be used to communicate with the UE, as described herein. Similarly, one or more receivers 935 may be used to communicate with network functions in the PLMN and/or RAN, as described herein. Although only one transmitter 930 and one receiver 935 are illustrated, the network apparatus 900 may have any suitable number of transmitters 930 and receivers 935. Further, the transmitter(s) 930 and the receiver(s) 935 may be any suitable type of transmitters and receivers.

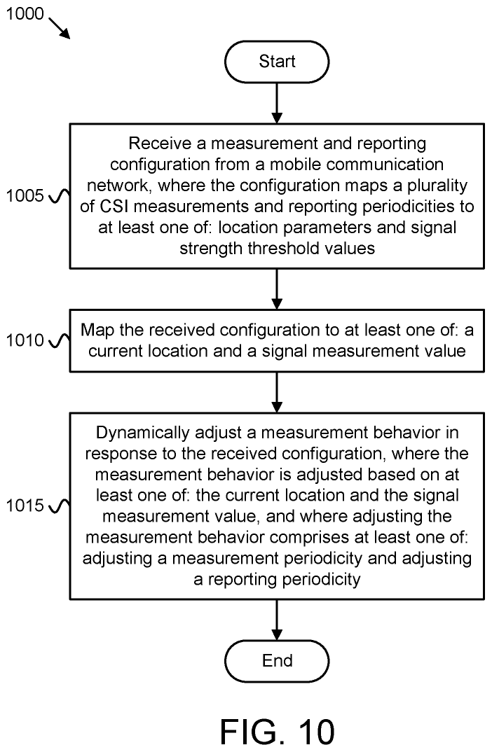

### FIG. 10—UE Method

FIG. 10 depicts one embodiment of a method 1000 for dynamically adapting a measurement behavior, according to embodiments of the disclosure. In various embodiments, the method 1000 is performed by a user equipment device, such as the remote unit 105, the UE 205, and/or the user equipment apparatus 800, as described above. In some embodiments, the method 1000 is performed by a processor, such as a microcontroller, a microprocessor, a CPU, a GPU, an auxiliary processing unit, a FPGA, or the like.

The method 1000 begins and receives 1005 a measurement-and-reporting configuration from a mobile communication network (i.e., gNB). Here, the configuration maps a plurality of CSI measurements and reporting periodicities to at least one of: location parameters and signal strength threshold values. The method 1000 includes mapping 1010 the received configuration to at least one of: a current location and a signal measurement value (i.e., measured signal strength). The method 1000 includes dynamically adjusting 1015 a measurement behavior in response to the received configuration. Here, the measurement behavior is adjusted based on at least one of: the current location and the signal measurement value, where adjusting the measurement behavior comprises at least one of: adjusting a measurement periodicity and adjusting a reporting periodicity. The method 1000 ends.

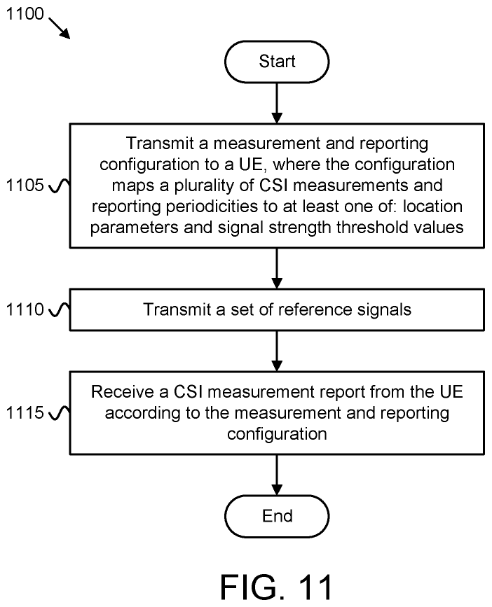

### FIG. 11—RAN Method

FIG. 11 depicts one embodiment of a method 1100 for dynamically adapting a measurement behavior, according to embodiments of the disclosure. In various embodiments, the method 1100 is performed by a network device in a mobile communication system, such as the base unit 121, the NTN gateway 125, the satellite 130, the satellite 201, a gNB and/or the network apparatus 900, as described above. In some embodiments, the method 1100 is performed by a processor, such as a microcontroller, a microprocessor, a CPU, a GPU, an auxiliary processing unit, a FPGA, or the like.

The method 1100 begins and transmits 1105 a measurement-and-reporting configuration to a UE. Here, the configuration maps a plurality of CSI measurements and reporting periodicities to at least one of: location parameters and signal strength threshold values. The method 1100 includes transmitting 1110 a set of reference signals. The method 1100 includes receiving 1115 a CSI measurement report from the UE according to the measurement-and-reporting configuration. The method 1100 ends. In some embodiments, the method 1100 is initiated based on an indication received from the UE, wherein transmitting 1105 the measurement-and-reporting configuration occurs in response to the indication from the UE.

### Claim Statements

### UE Apparatus

Disclosed herein is a first apparatus for dynamically adapting a measurement behavior, according to embodiments of the disclosure. The first apparatus may be implemented by a UE device, such as the remote unit 105, the UE 205, and/or the user equipment apparatus 800, described above. The first apparatus includes a processor and a transceiver (i.e., implementing a radio interface) that receives a measurement-and-reporting configuration from a mobile communication network (i.e., gNB). Here, the configuration maps a plurality periodicities, i.e., CSI measurements and/or reporting periodicities, to at least one of: location parameters and signal strength threshold values.

The processor maps the received configuration to at least one of: a current location and a signal measurement value (i.e., measured signal strength, such as L1-RSRP, L1-SINR, RSRQ, RSSI). The processor dynamically adjusts a measurement behavior in response to the received configuration. Here, the measurement behavior is adjusted based on at least one of: the current location and the signal measurement value (i.e., measured signal strength), where adjusting the measurement behavior includes at least one of: adjusting a measurement periodicity and a adjusting a reporting periodicity.

In some embodiments, the configuration includes a mapping table that maps a location parameter (e.g., a geographic area) with a corresponding CSI measurement periodicity, a corresponding CSI reporting periodicity, and/or a corresponding BWP configuration. In some embodiments, the configuration includes a mapping table that maps a received signal threshold value (or a range of signal strength values) with a corresponding CSI measurement periodicity, a corresponding CSI reporting periodicity, and/or a corresponding BWP configuration.

In some embodiments, dynamically adjusting the measurement behavior includes adjusting the measurement behavior based on a comparison of a measured signal strength to a received signal threshold value. In certain embodiments, the processor further performs signal strength measurements on both an active BWP and on at least one inactive BWP, e.g., when the measured signal strength is below the received signal threshold value.

In some embodiments, dynamically adjusting the measurement behavior includes adjusting the measurement behavior based on the current location. In certain embodiments, the processor further performs measurement on both an active BWP and also on at least one inactive BWP based on the current location, e.g., when the UE is located in a specific area or when the UE is within a predetermined distance from the beam boundary.

In some embodiments, the processor further requests the mobile communication network for triggering or activating a CSI measurement-and-reporting procedure, said request based on a signal measurement value or on a current location. In some embodiments, the processor further requests the mobile communication network for configuring a mapping table for CSI measurement periodicities and/or CSI reporting periodicities, said request based on a signal measurement value or on a current location.

In some embodiments, the transceiver further receives a second configuration (e.g., receives an RRC configuration message) that associates each configured BWP with a specific beam and receives DCI containing a BWP index in a BWP indication field. In such embodiments, the processor automatically switches to a beam associated with the indicated BWP in response to the BWP index in DCI. In certain embodiments, the second configuration associates a first BWP with a first beam by including a source RS with a QCL type-D assumption. In certain embodiments, when a BWP is associated with at least one beam, then the UE does not consider a TCI indication field in the corresponding DCI format.

In some embodiments, identifying a current location of the UE includes receiving an explicit indication from the mobile communication network. In some embodiments, the processor further triggers a BWP switch by sending a combined BWP and beam ID (e.g., BWP-ID & Beam ID). In some embodiments, the processor further triggers a beam switch by sending a combined BWP and beam ID (e.g., BWP-ID & Beam ID).

### UE Method

Disclosed herein is a first method for dynamically adapting a measurement behavior, according to embodiments of the disclosure. The first method may be performed by a UE device, such as the remote unit 105, the UE 205, and/or the user equipment apparatus 800, described above. The first method includes receiving a measurement-and-reporting configuration from a mobile communication network (i.e., gNB). Here, the configuration maps a plurality of CSI measurements and reporting periodicities to at least one of: location parameters and signal strength threshold values. The first method includes mapping the received configuration to at least one of: a current location and a signal measurement value (i.e., measured signal strength) and dynamically adjusting a measurement behavior in response to the received configuration. Here, the measurement behavior is adjusted based on at least one of: a current location and a signal measurement value (i.e., a measured signal strength), where adjusting the measurement behavior includes at least one of: adjusting a measurement periodicity and adjusting a reporting periodicity.

In some embodiments, the configuration includes a mapping table that maps a location parameter (e.g., a geographic area) with a corresponding CSI measurement periodicity, a corresponding CSI reporting periodicity, and/or a corresponding BWP configuration. In some embodiments, the configuration includes a mapping table that maps a received signal threshold value (or a range of signal strength values) with at least one of: a corresponding CSI measurement periodicity, a corresponding CSI reporting periodicity, and/or a corresponding BWP configuration.

In some embodiments, dynamically adjusting the measurement behavior includes adjusting the measurement behavior based on a comparison of a measured signal strength to a received signal threshold value. In such embodiments, the first method may further include performing signal strength measurements on both an active BWP and on at least one inactive BWP, e.g., when the measured signal strength is below the received signal threshold value.

In some embodiments, dynamically adjusting the measurement behavior includes adjusting the measurement behavior based on the current location. In such embodiments, the first method may further include performing signal strength measurements on both an active BWP and also on at least one inactive BWP, based on the current location, e.g., when the UE is located in a specific area or when the UE is within a predetermined distance from the beam boundary.

In some embodiments, the first method further includes requesting the mobile communication network for triggering or activating a CSI measurement-and-reporting procedure, said request based on a signal measurement value or on a current location. In some embodiments, the first method further includes requesting the mobile communication network to configure a mapping table for CSI measurement periodicities and/or CSI reporting periodicities, said request based on a signal measurement value or on a current location.

In some embodiments, the first method includes receiving a second configuration (e.g., receives an RRC configuration message) that associates each configured BWP with a specific beam and receiving DCI containing a BWP index in a BWP indication field. Here, the first method further includes automatically switching to a beam associated with the indicated BWP in response to the BWP index in DCI. In certain embodiments, the second configuration associates a first BWP with a first beam by including a source RS with a QCL type-D assumption. In certain embodiments, when a BWP is associated with at least one beam, then the UE does not consider a TCI indication field in the corresponding DCI format.

In some embodiments, identifying a current location of the UE includes receiving an explicit indication from the mobile communication network. In some embodiments, the first method further includes triggering a BWP switch by sending a combined BWP and beam ID (e.g., BWP-ID & Beam ID). In some embodiments, the first method further includes triggering a beam switch by sending a combined BWP and beam ID (e.g., BWP-ID & Beam ID).

### RAN Apparatus

Disclosed herein is a second apparatus for dynamically adapting a measurement behavior, according to embodiments of the disclosure. The second apparatus may be implemented by a device in a network device in a mobile communication system, such as the base unit 121, the NTN gateway 125, the satellite 130, the satellite 201, a gNB and/or the network apparatus 900, described above. The second apparatus includes a processor and a transceiver (i.e., implementing a radio interface) that transmits a measurement-and-reporting configuration to a UE. Here, the configuration maps a plurality of CSI measurements and reporting periodicities to at least one of: location parameters and signal strength threshold values. The processor controls the transmitter to transmit a set of reference signals and receive a CSI measurement report from the UE according to the measurement-and-reporting configuration.

In some embodiments, the receiver further receives an indication from the UE, wherein the processor initiates transmission of the measurement-and-reporting configuration based on the indication from the UE. In some embodiments, the transceiver receives a request from the UE for triggering or activating a CSI measurement-and-reporting procedure, said request based on a signal measurement value of the UE or on a current location of the UE. In some embodiments, the transceiver receives a request from the UE for configuring a mapping table for CSI measurement periodicities and/or CSI reporting periodicities, said request based on a signal measurement value of the UE or on a current location of the UE.

In some embodiments, the UE is configured with multiple BWPs. In such embodiments, the transceiver further transmits a second configuration (e.g., transmits a RRC configuration message) that associates each configured BWP with a specific beam and additionally transmits DCI containing a BWP index in a BWP indication field, where the DCI triggers the UE to switch to a beam associated with the indicated BWP in response to the BWP index in DCI. In certain embodiments, the second configuration associates a first BWP with a first beam by including a source RS with a QCL type-D assumption. In certain embodiments, when a BWP is associated with at least one beam, then the UE does not consider a TCI indication field in the corresponding DCI format.

In some embodiments, the configuration includes a mapping table that maps a location parameter (e.g., a geographic area) with a corresponding CSI measurement periodicity, a corresponding CSI reporting periodicity, and/or a corresponding BWP configuration. In some embodiments, the configuration includes a mapping table that maps a received signal threshold value (or a range of signal strength values) with a corresponding CSI measurement periodicity, a corresponding CSI reporting periodicity, and/or a corresponding BWP configuration. In some embodiments, the processor further identifies a current location of the UE and transmits an explicit indication of the current location to the UE.

### RAN Method

Disclosed herein is a second method for dynamically adapting a measurement behavior, according to embodiments of the disclosure. The second method may be performed by a network device in a mobile communication system, such as the base unit 121, the NTN gateway 125, the satellite 130, the satellite 201, a gNB and/or the network apparatus 900, described above. The second method includes transmitting a measurement-and-reporting configuration to a UE. Here, the configuration maps a plurality of CSI measurements and reporting periodicities to at least one of: location parameters and signal strength threshold values. The second method includes transmitting a set of reference signals and receiving a CSI measurement report from the UE according to the measurement-and-reporting configuration.

In some embodiments, the second method further includes receiving an indication from the UE, where transmitting the measurement-and-reporting configuration is based on the indication from the UE. In some embodiments, the second method includes receiving a request from the UE for triggering or activating a CSI measurement-and-reporting procedure, said request based on a signal measurement value or on a current location. In some embodiments, the second method includes receiving a request from the UE for configuring a mapping table for CSI measurement periodicities and/or CSI reporting periodicities, said request based on a signal measurement value or on a current location.

In some embodiments, the UE is configured with multiple bandwidth parts. In such embodiments, the second method may further include transmitting a second configuration (e.g., transmitting an RRC configuration message) that associates each configured BWP with a specific beam; and transmitting DCI containing a BWP index in a BWP indication field, where the DCI triggers the UE to switch to a beam associated with the indicated BWP in response to the BWP index in DCI. In certain embodiments, the second configuration associates a first BWP with a first beam by including a source RS with a QCL type-D assumption. In certain embodiments, when a BWP is associated with at least one beam, then the UE does not consider a TCI indication field in the corresponding DCI format.

In some embodiments, the configuration includes a mapping table that maps a location parameter (e.g., a geographic area) with a corresponding CSI measurement periodicity, a corresponding CSI reporting periodicity, and/or a corresponding BWP configuration. In some embodiments, the configuration includes a mapping table that maps a received signal threshold value (or a range of signal strength values) with a corresponding CSI measurement periodicity, a corresponding CSI reporting periodicity, and/or a corresponding BWP configuration. In some embodiments, the second method further includes identifying a current location of the UE and transmitting an explicit indication of the current location to the UE.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A User Equipment (“UE”) apparatus comprising:
a transceiver that receives a measurement-and-reporting configuration from a mobile communication network, wherein the measurement-and-reporting configuration maps a plurality of Channel State Information (“CSI”) measurements and reporting periodicities to at least one of: location parameters and measured signal strength threshold values; and
a processor that:
maps the received measurement-and-reporting configuration to at least one of: a current location and a signal measurement value; and
dynamically adjusts a measurement behavior in response to the received measurement-and-reporting configuration, wherein the measurement behavior is adjusted based on at least one of: the current location and the signal measurement value, wherein adjusting the measurement behavior comprises at least one of: adjusting a measurement periodicity and a adjusting a reporting periodicity.

2. The apparatus of claim 1, wherein the measurement-and-reporting configuration comprises a mapping table that maps a received signal threshold value to at least one of: a CSI measurement periodicity, a CSI reporting periodicity, and a bandwidth part (“BWP”) configuration.

3. The apparatus of claim 1, wherein the measurement-and-reporting configuration comprises a mapping table that maps a location parameter to at least one of: a CSI measurement periodicity, a CSI reporting periodicity, and a bandwidth part (“BWP”) configuration.

4. The apparatus of claim 1, wherein dynamically adjusting the measurement behavior comprises adjusting the measurement behavior based on a comparison of a measured signal strength to a received signal threshold value, wherein the processor further performs signal strength measurements on both an active bandwidth part (“BWP”) and on at least one inactive BWP.

5. The apparatus of claim 1, wherein dynamically adjusting the measurement behavior comprises adjusting the measurement behavior based on the current location, wherein the processor further performs measurement on both an active bandwidth part (“BWP”) and also on at least one inactive BWP based on the current location.

6. The apparatus of claim 1, wherein the processor further requests the mobile communication network for one of: triggering a CSI measurement-and-reporting procedure, and activating a CSI measurement-and-reporting procedure, said request based on at least one of: a signal measurement value and a current location.

7. The apparatus of claim 1, wherein the processor further requests the mobile communication network for configuring a mapping table for CSI measurement periodicities and/or CSI reporting periodicities, said request based on at least one of: a signal measurement value and a current location.

8. The apparatus of claim 1, wherein identifying a current location of the UE comprises receiving an explicit indication from the mobile communication network.

9. The apparatus of claim 1, wherein the transceiver further:
receives a second configuration that associates each configured bandwidth part (“BWP”) with a specific beam; and
receives Downlink Control Information (“DCI”) containing a BWP index in a BWP indication field,
wherein the processor automatically switches to a beam associated with the indicated BWP in response to the BWP index in DCI.

10. The apparatus of claim 9, wherein the second configuration associates a first BWP with a first beam by including a source reference signal (“RS”) with a Quasi-Co-Location (“QCL”) type-D assumption.

11. The apparatus of claim 9, wherein when a BWP is associated with at least one beam, then the UE does not consider a Transmission Configuration Indicator (“TCI”) indication field in the received DCI.

12. The apparatus of claim 1, wherein the processor further triggers a bandwidth part (“BWP”) switch by sending a combined BWP and beam identifier.

13. The apparatus of claim 1, wherein the processor further triggers a beam switch by sending a combined bandwidth part (“BWP”) and beam identifier.

14. A method of a User Equipment (“UE”), the method comprising:
receiving a measurement-and-reporting configuration from a mobile communication network, wherein the measurement-and-reporting configuration maps a plurality of Channel State Information (“CSI”) measurements and reporting periodicities to at least one of: location parameters and signal strength threshold values;
mapping the received measurement-and-reporting configuration to at least one of:
a current location and a signal measurement value; and
dynamically adjusting a measurement behavior in response to the received measurement-and-reporting configuration, wherein the measurement behavior is adjusted based on at least one of: the current location and the signal measurement value, wherein adjusting the measurement behavior comprises at least one of: adjusting a measurement periodicity and adjusting a reporting periodicity.

15. A method of a mobile communication network, the method comprising:
transmitting a measurement-and-reporting configuration to a User Equipment (“UE”), wherein the measurement-and-reporting configuration maps a plurality of Channel State Information (“CSI”) measurements and reporting periodicities to at least one of: location parameters and signal strength threshold values;
transmitting a set of reference signals; and
receiving a CSI measurement report from the UE according to the measurement-and-reporting configuration.
